(19) United States
(12) Patent Application Publication
(10) Pub. No.: US 2023/0386723 A1
(43) Pub. Date: Nov. 30, 2023

(54) NOISE FILTER, AND METHOD FOR MANUFACTURING FERRITE CORE

(71) Applicants: Ryota KUBO, Fukuoka (JP); DELLA MODA CO., LTD, Fukuoka (JP)

(72) Inventor: Ryota KUBO, Fukuoka (JP)

(21) Appl. No.: 18/032,107

(22) PCT Filed: Oct. 14, 2020
(86) PCT No.: PCT/JP2020/038719

§ 371 Date: Apr. 14, 2023

(51) Int. Cl. H01F 17/04; H01F 1/03; H01F 3/08; H01F 41/02

(52) U.S. Cl. CPC H01F 17/04; H01F 1/0315; H01F 3/08; H01F 41/0246

(57) ABSTRACT

A noise filter that is capable of efficiently removing noise even in a case where a ferrite core having two divided core portions is used. The noise filter includes a tubular ferrite core. The ferrite core includes two divided core portions. The two divided core portions are configured to be divided along divided end surfaces in an axial direction of the ferrite core. The two divided core portions include a platinum group metal in an amount of 0.5% to 2.0% with respect to the total weight of a ferrite powder.

### CROSS-REFERENCE TO RELATED APPLICATION

This application is the National Stage of International Application PCT/JP2020/038719 filed on Oct. 14, 2020, the entire disclosure of which is incorporated herein by reference.

### FIELD

The present disclosure relates to a noise filter and a method for manufacturing a ferrite core used for the noise filter.

### BACKGROUND

Conventionally, a noise filter that absorbs electromagnetic waves and removes noise by using a ferrite core has been known (for example, see Patent Literature 1: JP H5-275241 A).

In the conventional noise filter, the ferrite core is formed in a tubular shape and is divided into two divided core portions. The divided core portions are provided in a case that can be opened and closed so that divided end surfaces contact each other. Thereby, the noise filter can be attached by surrounding a cable or the like. Therefore, the conventional noise filter can be mounted even with an already connected cable or the like.

### SUMMARY

However, in the conventional noise filter described above, the cable or the like is surrounded by the ferrite core by placing the cable or the like between the divided core portions. However, the noise-removing effect of such a noise filter is reduced compared to a noise filter that uses an undivided cylindrical ferrite core is used and through which a cable or the like is passed.

The present disclosure has been made in view of the above circumstances, and an object thereof is to provide a noise filter capable of efficiently removing noise even in a case where a ferrite core having two divided core portions is used.

In order to solve the above problems, a noise filter of the present disclosure includes a tubular ferrite core and the ferrite core includes two divided core portions. The two divided core portions are configured to be divided along divided end surfaces in an axial direction of the ferrite core. The two divided core portions include a platinum group metal in an amount of 0.5% to 2.0% with respect to the total weight of a ferrite powder.

In addition, a method for manufacturing a ferrite core of the present disclosure is for manufacturing a tubular ferrite core used for a noise filter. The method includes a powder preparation step for preparing a ferrite powder; a composition preparation step for preparing a ferrite composition by mixing a binder with the ferrite powder; a molding step for molding the ferrite composition into two divided core portions, the two divided core portions being obtained by dividing the ferrite core along divided end surfaces of the two divided core portions in an axial direction of the ferrite core; and a sintering step for sintering the molded divided core portions. During preparing the ferrite powder, a platinum group metal is blended in an amount of 0.5% to 2.0% with respect to the total weight of the ferrite powder.

### BRIEF DESCRIPTION OF THE DRAWINGS

FIG. 1 is an explanatory view illustrating an overall configuration of a noise filter of a first embodiment as an example of a noise filter according to the present disclosure.

FIG. 2 is an explanatory view illustrating a state in which two divided core portions as a ferrite core are separated in the noise filter.

FIG. 3 is a flowchart illustrating a method for manufacturing the ferrite core for manufacturing each of the divided core portions of the ferrite core used for the noise filter.

FIG. 4 is an explanatory view illustrating an example of disposing the noise filter.

### DETAILED DESCRIPTION OF EMBODIMENTS

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

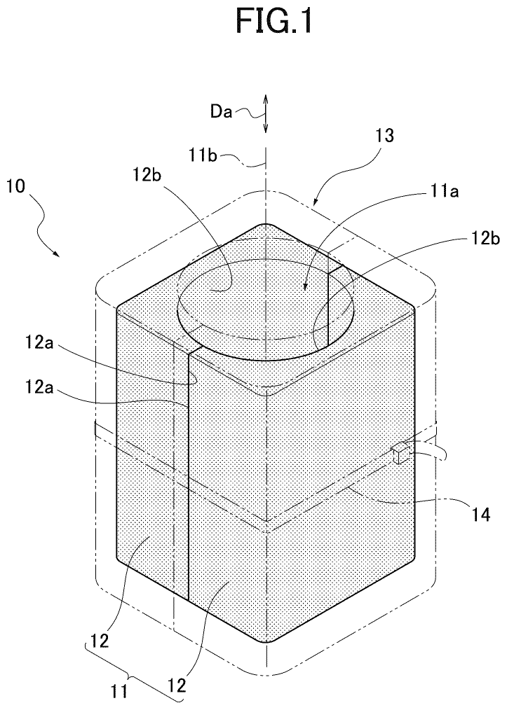

Hereinafter, a first embodiment of a noise filter 10 as an embodiment of a noise filter according to the present disclosure will be described with reference to FIGS. 1 to 4.

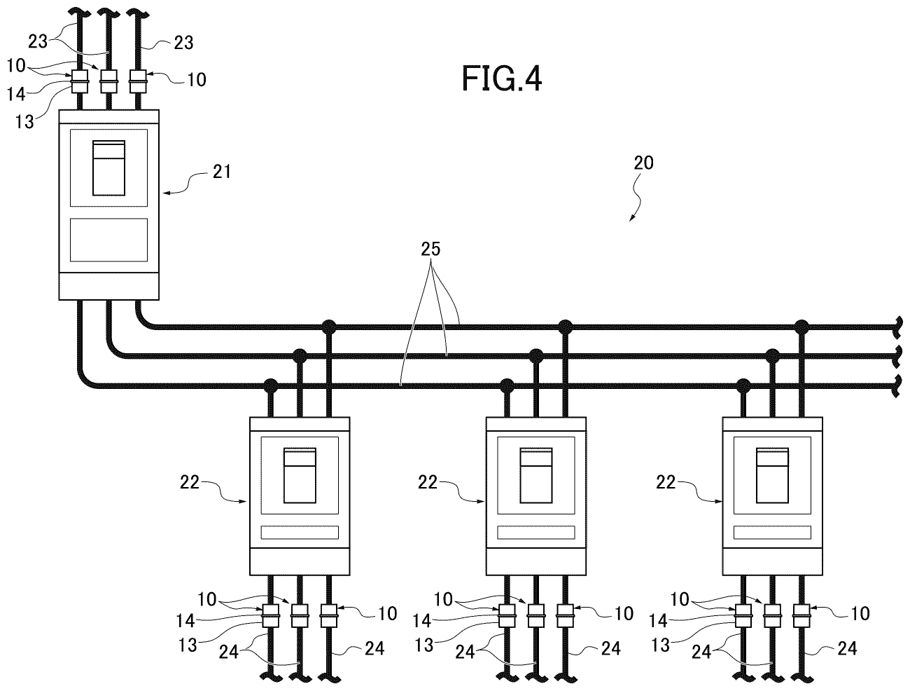

Note that, in FIG. 1, a case 13 and a binding band 14 are indicated by broken lines to facilitate understanding of a state of a ferrite core 11 accommodated in the case 13 in the noise filter 10. In addition, in FIG. 4, a configuration of a switchboard is illustrated in a simplified manner to facilitate understanding of a state in which the noise filters 10 are provided.

### First Embodiment

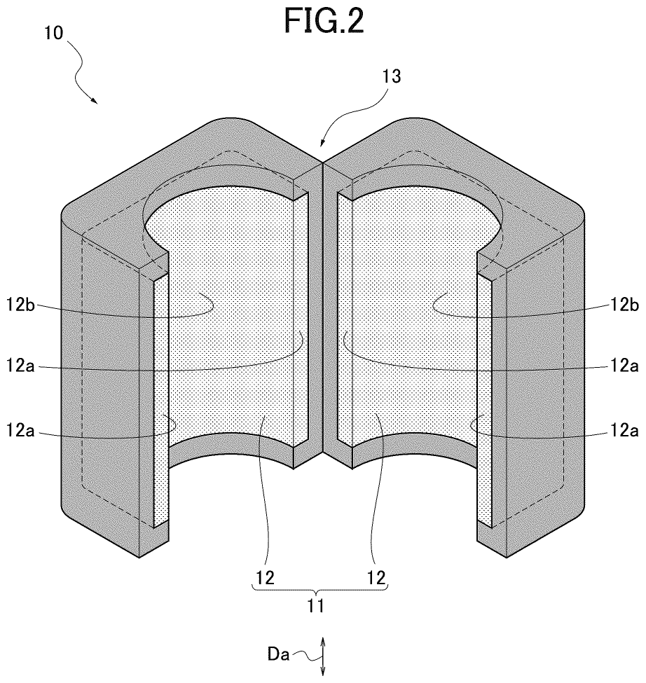

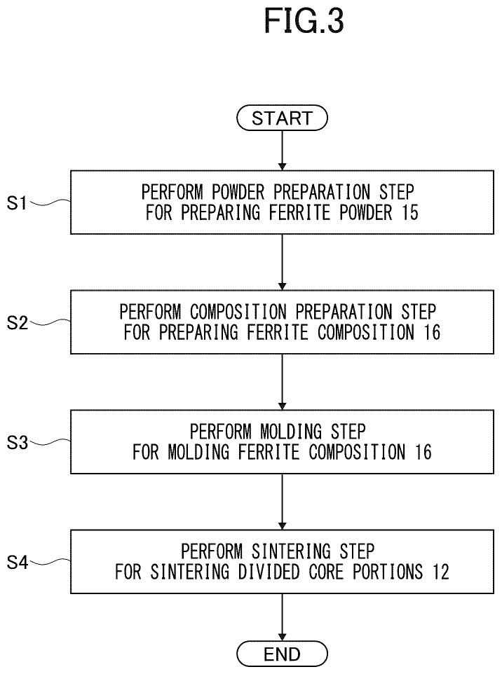

As illustrated in FIGS. 1 and 2, the noise filter 10 according to the present disclosure is configured by placing the ferrite core 11 in the case 13. The ferrite core 11 is formed of a ferrite powder 15 (see FIG. 3) which is a powder raw material containing iron oxide as a main component and absorbs high-frequency electromagnetic waves as noise. The ferrite core 11 is manufactured by molding and sintering the ferrite powder 15. The manufacture will be described below.

The ferrite core 11 of the first embodiment has a tubular shape and an elongated quadrangular prismatic outer shape. The ferrite core 11 includes a cylindrical hollow portion 11a formed inside thereof. The ferrite core 11 includes two divided core portions 12. The divided core portions 12 divide the ferrite core 11 into two parts along a plane including an axial line 11b of the ferrite core 11. Hereinafter, a direction in which the axial line 11b extends is referred to as an axial direction Da of the ferrite core 11 (divided core portion 12).

Each of the divided core portions 12 includes a pair of divided end surfaces 12a extending in the axial direction Da and an elongated groove portion 12b. Each of the divided end surfaces 12a has a rectangular shape elongated in the axial direction Da (see FIG. 2). The groove portion 12b extends from one end to the other end of the divided core portion 12 in the axial direction Da. The groove portion 12b has a semicircular shape in a cross-section orthogonal to the axial direction Da. That is, in a state in which the ferrite core 11 is formed, the divided end surfaces 12a of the divided core portions 12 abut with each other on the plane. The divided core portions 12 are divided (equally divided into two) in half along the plane interposed therebetween. The cylindrical hollow portion 11a is formed by arranging the divided core portions 12 facing each other and abutting the divided end surfaces 12a of the divided core portions 12 against each other, thereby forming the tubular ferrite core 11.

The case 13 accommodates the ferrite core 11 to cover the ferrite core 11 from the outside. The case 13 can individually accommodate the divided core portions 12. In addition, the case 13 can be opened and closed about an opening and closing axis in the axial direction Da. Therefore, in the case 13, the individually accommodated divided core portions 12 can be in a state in which the groove portions 12b are opened (see FIG. 2), and can be in a state in which the ferrite core 11 is formed by abutting the divided end surfaces 12a to each other (see FIG. 1). The case 13 can bring the divided end surfaces 12a of the accommodated divided core portions 12 into close contact with each other in a closed state.

As illustrated in FIG. 1, the noise filter 10 of the first embodiment is provided with a binding band 14 as a closely fixing portion. The binding band 14 is configured to maintain the state in which the ferrite core 11 is formed by the divided core portions 12 and fix the case 13 in a closed state. In the fixed state, the binding band 14 presses the opposite divided end surfaces 12a of the two divided core portions 12 accommodated in the case 13 with a sufficient force (pressure) to bring the divided end surfaces 12a into close contact with each other. The sufficient force herein means that at least the divided end surfaces 12a are brought into close contact with each other in a state of being pressed against each other. Note that the closely fixing portion is not limited to the binding band 14 of the first embodiment. The closely fixing portion may be provided in the case 13 as long as the case 13 is fixed in a closed state to bring the ferrite core 11 into a state of being formed by the divided core portions 12 while bringing the respective divided end surfaces 12a into close contact with each other. The closely fixing portion may be formed of a string, a cord, a belt, or the like.

Next, a method (manufacturing process) for manufacturing the ferrite core 11 used for the noise filter 10 will be described with reference to FIG. 3. In the manufacturing method of the first embodiment, the ferrite core 11 includes two divided core portions 12, and accordingly, each of the divided core portions 12 is manufactured. Hereinafter, each step for the flowchart of FIG. 3 will be described.

In Step S1, a powder preparation step for preparing the ferrite powder as a raw material is performed. Then, the process proceeds to Step S2. In Step S1, a platinum group metal is added to a material of a general ferrite powder 15 to prepare the ferrite powder 15. The material of the general ferrite powder 15 is, for example, an oxide consisting of a transition metal such as iron, nickel, copper, zinc, manganese, silicon, and oxygen. The blending ratio of the materials (composition ratio of elements) is appropriately set according to noise characteristics at a location to be used. The platinum group metal includes ruthenium (Ru), rhodium (Rh), palladium (Pd), osmium (Os), iridium (Ir), and platinum (Pt). The platinum group metal is present in a range of a weight of 0.5% to 2.0% (weight percent) with respect to the total weight of the ferrite powder 15 after the blending stage. In the first embodiment, as an example of the platinum group metal, rhodium having high purity is blended. Note that, the platinum group metal is not limited to the configuration of the first embodiment. A high-purity platinum group metal or a commercially available platinum group metal chloride may be used as the platinum group metal as long as the platinum group metal has a weight of 0.5% to 2.0% with respect to the total weight of the ferrite powder 15 after the blending stage.

In Step S2, a composition preparation step for preparing a ferrite composition 16 is performed. Then, the process proceeds to Step S3. In Step S2, a binder is mixed with the ferrite powder 15 prepared in Step S1 to prepare the ferrite composition 16. The binder is generally used for forming the ferrite core, and for example, a thermoplastic resin or a surface active agent may be used as the binder. In Step S2, the ferrite powder 15 and the binder (thermoplastic resin or surface active agent) are appropriately premixed or heated and kneaded to prepare the ferrite composition 16.

In Step S3, a molding step for molding the ferrite composition 16 is performed. Then, the process proceeds to Step S4. In Step S3, the ferrite composition 16 prepared in Step S2 is molded into a predetermined shape using a mold. The predetermined shape is the shape of the divided core portion 12 in the first embodiment. That is, in Step S3, the divided core portions 12 before sintering are molded from the ferrite composition 16. In Step S3, for example, the ferrite composition 16 is molded by injecting the ferrite composition 16 into a mold of an injection molding device. In addition, in Step S3, a degreasing step for removing the binder from the ferrite composition 16 in the mold (so-called degreasing) is performed. The degreasing step may be performed by appropriately setting a temperature and time for degreasing according to the binder mixed in Step S2.

In Step S4, a sintering step for sintering the divided core portion 12 is performed. Then, the method for manufacturing the ferrite core 11 is terminated. In Step S4, the ferrite composition 16 molded in the molding step (including the degreasing step) is sintered to form the divided core portion 12. Step S4 is performed by appropriately setting a temperature and time for sintering according to the material of the ferrite powder used.

Next, the mounting of the noise filter 10 will be described. The noise filter 10 is attached to an electromagnetic wave generating source that generates electromagnetic waves that become noise in the device. The noise filter 10 is used to absorb the electromagnetic waves and remove the noise. The noise filter 10 of the first embodiment is applied to a distribution board 20 as illustrated in FIG. 4 as an example. In the distribution board 20, three electric leakage breakers 22 are connected to an ampere breaker 21 for a contract. Three input power cables or lines 23 are connected to each of the ampere breakers 21, and three output power cables or lines 24 are connected to each of the electric leakage breakers 22. The ampere breaker 21 and each of the electric leakage breakers 22 are connected by three power cables or lines 25.

Here, in general, the noise is a high-frequency component (a frequency that is an integral multiple of the fundamental wave) included in a switching frequency of a switching power supply or the like and is a current having a frequency component (so-called a high frequency) much higher than the frequency of a signal current. Such noise is radiated from an integrated circuit (i.e., IC), a power line (or cable), or the like of the electronic device. The noise filter 10 of the present disclosure can be mounted on the power line and reduces noise from the power line.

In the noise filter 10, the groove portions 12b are opened by opening the case 13 and abut with each other with target power lines 23 and 24, and then the case 13 is closed and the divided end surfaces 12a abut each other. Thereby, the noise filter 10 is in a state in which the ferrite core 11 is formed. Then, the noise filter 10 is brought into a state in which the opposite divided end surfaces 12a are brought into close contact with each other by attaching and tightening the binding band 14 to the case 13 (see FIG. 1). Thus, the noise filters 10 are mounted on the target power lines 23 and 24, and the power lines 23 and 24 are surrounded by the ferrite core 11. Therefore, even when the power lines 23 and 24 are already connected, the noise filters 10 can be mounted on the power lines 23 and 24 without being detached from the distribution board 20.

In the example illustrated in FIG. 4, the noise filters 10 are attached to three of the input power lines 23, and the noise filters 10 are attached to two of the output power lines 24 excluding the neutral (earth (neutral line)). This is because it is considered that high frequencies are emitted in all the input power lines 23, but it is considered that high frequencies are not emitted in the neutral of the output power line 24. Note that the power line (electromagnetic wave generating source) to which the noise filter 10 is attached may be any power line as long as it is considered to generate electromagnetic waves that become noise in the device, and the number and the attached location may be appropriately selected, but are not limited to the example of FIG. 4.

When each of the noise filters 10 is attached to the power lines 23 and 24 which are electromagnetic wave generating sources, magnetic fields generated in the power lines 23 and 24 are collected to the ferrite core 11. Then, the noise filter 10 converts the magnetic energy into heat by a magnetic loss in the ferrite core 11, and releases the heat from the ferrite core 11 to the surrounding atmosphere through the case 13, thereby attenuating the noise. By attenuating the noise (reactive power), the noise filter 10 can allow a clean current to flow in the device to reduce a load on the device so that power consumption can be reduced.

Here, there is a conventional noise filter in which a tubular ferrite core is formed by two divided core portions, and the noise filter can be attached to an already connected power line. However, in the conventional noise filter, even in a state in which the ferrite core is formed by abutting the divided end surfaces with each other, an effect of reducing noise and power consumption is reduced compared to the noise filter using a tubular ferrite core that has the same characteristics and is not divided. It is considered that the reason for the reduced effect is that the hardness of each of the divided core portions is not sufficient, such that the divided end surfaces cannot be sufficiently pressed and brought into close contact with each other.

On the other hand, in the noise filter 10 of the present disclosure, rhodium is blended with the ferrite powder of each of the divided core portions 12 as the ferrite core 11 in a weight range of 0.5% to 2.0%. Therefore, the noise filter 10 can increase the hardness of each of the divided core portions 12 compared to a ferrite core in which rhodium is not blended. Accordingly, the noise filter 10 can prevent each of the divided core portions 12 from being deformed even when the divided end surfaces 12a are pressed against each other with a sufficient force (pressure) and brought into close contact with each other. Thus, the noise filter 10 can achieve the same or better effect of reducing noise and power consumption compared to the noise filter using an undivided tubular ferrite core having the same characteristics. In addition, the noise filter 10 can stabilize the effect of converting a high frequency into heat compared to the ferrite core in which rhodium is not blended, and accordingly, the effect of reducing noise and power consumption can be improved.

In addition, the noise filter 10 has an elongated quadrangular prismatic outer shape in a state in which the ferrite core 11 is formed by combining the divided core portions 12. Therefore, the noise filter 10 can increase an area of an outer surface while having a simple configuration compared to, for example, a cylindrical ferrite core, can promote a release of heat converted from a high frequency to the outside, and can improve the noise reduction effect.

The applicant has tested the usefulness of the noise filter 10 using an escalator that has already been installed, which is referred to as a first experiment. In the first experiment, the power consumption in a case where the noise filter 10 was not mounted and the power consumption in a case where each noise filter 10 was mounted on a distribution board connected to the escalator in the same manner as in FIG. 4 were measured and compared. In addition, in the first experiment, the measurements were made at the same time interval in different time zones on the same day to make the conditions for both cases as similar as possible. As a result of the first experiment, in the case where the noise filter 10 was mounted, the power consumption could be reduced by 7.48% compared to the case where the noise filter was not mounted.

In addition, the applicant experimented on the usefulness of the noise filter 10 using two freezing showcases, which is referred to as a second experiment. In the second experiment, the power consumption was measured without mounting the noise filter 10 on one of the freezing showcases, and the power consumption was measured by mounting the noise filters 10 on the other freezing showcase to which a distribution board was connected in the same manner as in FIG. 4. Then, the measured values were compared. In addition, in the second experiment, the two freezing showcases were installed side by side on the same site on the same day, and measurements were made at the same time interval at the same time to make the conditions for both cases as similar as possible. As a result of the second experiment, in the case where the noise filter 10 was mounted, the power consumption could be reduced by 5.72% compared to the case where the noise filter was not mounted.

The noise filter 10 of the first embodiment of the ferrite core according to the present disclosure can achieve the following effects.

In the noise filter 10, the tubular ferrite core 11 includes two divided core portions 12 divided along the divided end surfaces 12a in the axial direction of the tubular ferrite core 11. The two divided core portions 12 include the platinum group metal in an amount of 0.5% to 2.0% with respect to the total weight of the ferrite powder. Therefore, the noise filter 10 can achieve the same effect of reducing noise and power consumption compared to a case of using a tubular ferrite core that is not divided and has the same characteristics. In addition, the noise filter 10 can improve the effect of reducing noise and power consumption compared to a ferrite core in which a platinum group metal is not included or blended.

In addition, in the noise filter 10, rhodium is used as the platinum group metal. Therefore, the noise filter 10 can improve the effect of reducing noise and power consumption in the device to which the electromagnetic wave generating source (the power lines 23 and 24 in the first embodiment) is connected.

Furthermore, the noise filter 10 is mounted on the electromagnetic wave-generating source by bringing the divided end surfaces 12a of the ferrite core 11 into close contact with each other and combining the two divided core portions 12 in a state where the electromagnetic wave-generating source (the power lines 23 and 24 in the first embodiment) is received in the hollow portion 11a. Therefore, the noise filter 10 can be mounted on the electromagnetic wave generating source without removing the electromagnetic wave generating source even when the electromagnetic wave generating source (the power lines 23 and 24 in the first embodiment) is already connected.

The ferrite core 11 includes a hollow portion 11a which has a cylindrical shape. The ferrite core 11 has a prismatic outer shape. Therefore, the noise filter 10 can increase the area of the outer surface while having a simple configuration, can promote the release of heat converted from the high frequency to the outside, and can enhance the noise reduction effect.

A method for manufacturing a ferrite core, the ferrite core being a tubular ferrite core 11 used for the noise filter 10, the method includes a powder preparation step (S1) for preparing a ferrite powder; a composition preparation step (S2) for preparing a ferrite composition 16 by mixing a binder with the ferrite powder; a molding step (S3) for molding the ferrite composition 16 into the divided core portions 12, the divided core portions 12 being obtained by dividing the ferrite core 11 along the divided end surfaces 12a in an axial direction of the ferrite core 11; and a sintering step (S4) for sintering the molded divided core portions 12. Then, in the method for manufacturing the ferrite core, a platinum group metal is blended in an amount of 0.5% to 2.0% with respect to the total weight of the ferrite powder in the powder preparation step. Therefore, the method for manufacturing the ferrite core can achieve the same or better effect of reducing noise and power consumption compared to the tubular ferrite core. According to the method for manufacturing the ferrite core, it is possible to form the divided core portions 12 that can improve the effect of reducing noise and power consumption compared to the ferrite core in which a platinum group metal is not blended.

In the method for manufacturing the ferrite core, rhodium is used as the platinum group metal. Therefore, in the method for manufacturing the ferrite core, it is possible to form the divided core portions 12 that can improve the effect of reducing noise and power consumption in the device to which the electromagnetic wave generating source (the power lines 23 and 24 in the first embodiment) is connected.

Therefore, in the noise filter 10 as an embodiment of the noise filter according to the present disclosure, noise can be effectively removed even in a case where the ferrite core 11 having the two divided core portions 12 is used.

Although the noise filter of the present disclosure has been described above based on the first embodiment, a specific configuration of the noise filter is not limited to the first embodiment, and changes in design, additions, and the like are allowed without departing from the gist of the disclosure according to each claim.

For example, in the first embodiment, rhodium is used as the platinum group metal. However, the platinum group metal is not limited to the rhodium exemplified in the first embodiment. The material to be blended in the range of the weight of 0.5% to 2.0% (weight percent) with respect to the total weight of the ferrite powder 15 may be a platinum group metal, that is, ruthenium, palladium, osmium, iridium, or platinum. Even in these cases, the noise filter can achieve the same effect as in the case of using rhodium.

Furthermore, in the first embodiment, the ferrite core 11 is formed by combining the two divided core portions 12 and has a size that can be mounted on the power lines 23 and 24 of the distribution board 20. However, the ferrite core is not limited to the configuration of the first embodiment. The size and shape of the ferrite core may be appropriately set according to the electromagnetic wave generating source as long as the ferrite core 11 can be mounted on an electromagnetic wave generating source that generates the electromagnetic waves that become noise in the device.

Moreover, in the first embodiment, the divided core portions 12 are configured to be obtained by dividing the ferrite core 11 into two portions along the plane including the axial line 11b of the ferrite core 11. However, the divided core portions 12 are not limited to the configuration in the first embodiment. The divided core portions may have different sizes and shapes as long as the divided core portions 12 are divided into two divided core portions along the divided end surfaces in the axial direction of the ferrite core 11.

In the first embodiment, the divided core portions 12 are accommodated in the case 13. However, the divided core portions 12 are not limited to the configuration of the first embodiment. The case 13 may not be provided as long as both the divided core portions 12 are changeable between a state in which the groove portions 12b are opened and a state in which the divided end surfaces 12a abut with each other to form the ferrite core 11, and the divided end surfaces 12a are brought into close contact with each other when the ferrite core 11 is formed.

1. A noise filter comprising:
a tubular ferrite core,
wherein the ferrite core comprises two divided core portions, the two divided core portions being configured to be divided along divided end surfaces in an axial direction of the ferrite core, and
wherein the two divided core portions comprise a platinum group metal in an amount of 0.5% to 2.0% with respect to the total weight of a ferrite powder.

2. The noise filter according to claim 1, wherein the platinum group metal is rhodium.

3. The noise filter according to claim 1, wherein the noise filter is configured to be mounted on an electromagnetic wave-generating source by bringing the divided end surfaces into close contact with each other to combine the two divided core portions in a state where the electromagnetic wave-generating source is accommodated in a hollow portion of the ferrite core, the electromagnetic wave generating source generating an electromagnetic wave that becomes noise in a device.

4. The noise filter according to claim 1, wherein the ferrite core comprises a hollow portion, and the hollow portion has a cylindrical shape, and
an outer shape of the ferrite core has a prismatic shape.

5. A method for manufacturing a ferrite core,
wherein the ferrite core is a tubular ferrite core used for a noise filter,
wherein the method comprises:
preparing a ferrite powder;
preparing a ferrite composition by mixing a binder with the ferrite powder;
molding the ferrite composition into two divided core portions, the two divided core portions being obtained by dividing the ferrite core along divided end surfaces in an axial direction of the ferrite core; and
sintering the molded divided core portions,
wherein during preparing the ferrite powder, a platinum group metal is blended in an amount of 0.5% to 2.0% with respect to the total weight of the ferrite powder.

6. The method according to claim 5, wherein the platinum group metal is rhodium.
